(19) United States
(12) Patent Application Publication
(10) Pub. No.: US 2008/0153824 A1
(43) Pub. Date: Jun. 26, 2008

(54) Method for Controlling Fungal Diseases in Leguminous Plants

(75) Inventors: John-Bryan Speakman, Bobenheim (DE); Reinhard Stierl, Freinsheim (DE); Siegfried Strathmann, Limburgerhof (DE); Peter Dombo, Wiesbaden (DE); Matthias Niedenbruck, Limburgerhof (DE); Egon Haden, Kleinniedesheim (DE); Dirk Voeste, Limburgerhof (DE); Ulf Groeger, Neuhofen (DE)

Correspondence Address: HUTCHISON LAW GROUP PLLC, PO BOX 31686, RALEIGH, NC, 27612, US

(73) Assignee: BASF Aktiengesellschaft, Ludwigshafen (DE)

(21) Appl. No.: 11/793,617

(22) PCT Filed: Dec. 16, 2005
(86) PCT No.: PCT/EP2005/013552

§ 371 Date: Jun. 18, 2007

(30) Foreign Application Priority Data
Dec. 20, 2004 (DE) 10 2004 062 455.0

(51) Int. Cl. A01N 37/50; A01N 43/653; A01P 3/00; A01N 43/50; A01N 43/56; A01N 43/54; A01N 43/34; A01N 43/36; A01N 43/84; A01N 47/28; A01N 37/00

(52) U.S. Cl. 514/237.5; 514/620; 514/383; 514/406; 514/266.3; 514/355; 514/422; 514/391; 514/275; 514/584; 514/538

(57) ABSTRACT

Method for controlling rust infections in leguminous plants by using orysastrobin, mixtures of orysastrobin and a fungicidally active compound II from the group of the azoles, acylalanines, amine derivatives, anilinopyrimidines, dicarboximides, dithiocarbamates, heterocylic compounds, phenylpyrroles, cinnamides, and analogs, or other fungicides according to the description, and also compositions and seed comprising these mixtures.

The invention relates to a method for controlling rust infections in leguminous plants.

Until recently, in the most important regions for the cultivation of leguminous plants (in particular soybeans) there were no infections with harmful fungi such as rust of economic significance. However, over recent years, there has been an increase in severe rust infections of soybean crops in South America by the harmful fungi Phakopsora pachyrhizi and Phakopsora meibomiae. There have been considerable harvest and yield losses.

Most customary fungicides are unsuitable for controlling rust in soybeans.

Surprisingly, it has now been found that orysastrobin of the formula I

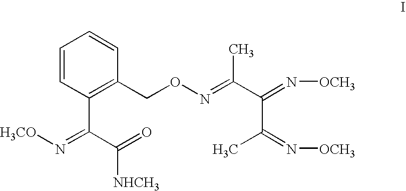

has excellent activity against rust fungus diseases of leguminous plants.

Orysastrobin, (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide, is known from WO-A 97/15552 as a fungicide which acts specifically against rice pathogens (see also www.hclrss.demon.co.uk).

Synergistic orysastrobin mixtures especially formulated for rice diseases are known from WO 99/48365, WO 99/48366, WO 99/48367, WO 99/48368, WO 99/48369 and WO 99/48370.

The active compounds described in the present invention as mixing partners are known in a general manner to the person skilled in the art (cf. http://www.hclrss.demon.co.uk/) and are commercially available.

Harmful fungi are controlled by application of orysastrobin by treating seed, by spraying or dusting the plants or the soil before or after sowing of the plants or before or after emergence of the plants.

The control of rust diseases on leguminous plants is advantageously carried out by applying an aqueous preparation of a formulation comprising orysastrobin to the above-ground parts of the plant, in particular leaves, or, by virtue of the high systemic action, may be carried out prophylactically by treating the seed or the soil.

A considerably enhanced activity in the method according to the invention is achieved by using orysastrobin together with at least one active compound II from the following group, in synergistically effective amounts:
azoles, such as bromoconazole, cyproconazole, difenoconazole, epoxiconazole, fluquinconazole, flusilazole, flutriafol, hexaconazole, imazalil, metconazole, myclobutanil, penconazole, propiconazole, prochloraz, prothioconazole, tebuconazole, tetraconazole, triadimefon, triadimenol, triticonazole,
acylalanines, such as benalaxyl, metalaxyl, mefenoxam, ofurace, oxadixyl,
amine derivatives, such as guazatine,
anilinopyrimidines, such as pyrimethanil, mepanipyrim or cyprodinil,
dicarboximides, such as iprodione, procymidone, vinclozolin,
dithiocarbamates, such as mancozeb, metiram, thiram,
heterocylic compounds, such as benomyl, boscalid, carbendazim, carboxin, oxycarboxin, fuberidazole, picobenzamid, penthiopyrad, proquinazid, thiabendazole, thiophanate-methyl,
phenylpyrroles, such as fenpiclonil or fludioxonil,
other fungicides, such as benthiavalicarb, cyflufenamid, fosetyl, fosetyl-aluminum, phosphorous acid or its salts, iprovalicarb, metrafenone,
cinnamides and analogs, such as dimethomorph, flumetover or flumorph.

The combinations of orysastrobin with in each case one of the above-mentioned active compounds II are novel.

It has been found that simultaneous, that is joint or separate, application of orysastrobin and at least one compound II or successive application of orysastrobin and an active compound II allows better control than is possible with the individual compounds (synergistic mixtures).

Accordingly, the invention also relates to fungicidal mixtures for controlling rust fungi, which mixtures comprise, as active components,
A) orysastrobin of the formula I, and
B) an active compound II as defined above in synergistically effective amounts.

Orysastrobin and the active compound II can be applied simultaneously, that is jointly or separately, or in succession, the sequence, in the case of separate application, generally not having any effect on the result of the control measures.

The compounds I and II are usually applied in a weight ratio of from 100:1 to 1:100, preferably from 20:1 to 1:20, in particular from 10:1 to 1:10.

In the method according to the invention, orysastrobin can advantageously be applied together with other active compounds III, in addition to the active compounds II also with herbicides, insecticides, growth regulators, further fungicides or else with fertilisers. Suitable further mixing partners III of this nature are in particular:
imazethapyr, imazamox, imazapyr, imazapic or dimethenamid-p;
fipronil, imidacloprid, acetamipird, nitenpyram, carbofuran, carbosulfan, benfuracarb, thiacloprid, clothianidin, MTI 446 or CGA 293343. The insecticide mixtures are known from WO 99/48366 and WO 03/059067.

The compounds I and II are usually applied in a weight ratio of from 100:1 to 1:100, preferably from 20:1 to 1:20, in particular from 10:1 to 1:10.

The mixtures, described above, of orysastrobin with herbicides are used in particular in crops in which the sensitivity of the plants to these herbicides, in particular the active imidazolinone compounds, is reduced.

When orysastrobin is used in soybeans, the yields are increased considerably. Thus, orysastrobin may also be used to increase the yield. By virtue of the yield increase in combination with the excellent action of orysastrobin against rust diseases in leguminous plants, the method according to the invention is of particular benefit to the farmer. Excellent results can be achieved by using orysastrobin in combination with an active compound II.

The method accoding to the invention also allows very good control of other harmful fungi frequently encountered in leguminous plants. The most important fungal diseases in soybeans are the following:
Microsphaera diffusa
Cercospora kikuchi
Cercospora sojina
Septoria glycines
Colletotrichum truncatum

Orysastrobin and the mixtures described above are also suitable for controlling the abovementioned diseases.

In addition, orysastrobin and the mixtures according to the invention are also highly effective against Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton and lawns, Ustilago species on cereals and sugar cane, Venturia inaequalis on apples, Bipolaris and Drechslera species on cereals and lawns, Septoria species on wheat, Botrytis cinerea on strawberries, vegetables, ornamental plants and grapevines, Mycosphaerella species on bananas, peanuts and cereals, Pseudocercosporella herpotrichoides on wheat and barley, Phytophthora infestans on potatoes and tomatoes, Pseudoperonospora species on cucurbits and hops, Plasmopara viticola on grapevines, Alternaria species on vegetables and fruit and also Fusarium and Verticillium species.

Particularly suitable for these applications are mixtures of orysastrobin with one of the fungicidally active compounds II mentioned above.

Particularly suitable for the method according to the invention are mixtures of orysastrobin with an azole such as cyproconazole, epoxiconazole, flutriafol, metconazole, tebuconazole, triticonazole, metalaxyl, pyrimethanil, iprodione, dimethomorph, metiram, boscalid, thiophanate-methyl, penthiopyrad, fludioxonil, metrafenone, cyflufenamid or proquinazid.

Orysastrobin and the orysastrobin mixtures are applied by treating the fungi or the plants or materials to be protected against fungal attack or the soil with a fungicidally effective amount of the active compounds. Application can be both before and after the infection of the materials or plants with the fungi. The treatment is preferably carried out prior to the infection.

The fungicidal compositions generally comprise from 0.1 to 95% by weight, preferably from 0.5 to 90% by weight, of the active compound.

When orysastrobin is used in its own, the application rates in the method accoding to the invention are from 0.01 to 1.5 kg of active compound per ha, depending on the type of effect desired.

In the treatment of seed, the amounts of active compound required are generally from 1 to 1500 g of orysastrobin, preferably from 10 to 500 g, per 100 kilogram of seed.

Depending on the type of active compound II and the desired effect, the application rates of the mixtures according to the invention are from 10 g/ha to 2500 g/ha, preferably from 50 to 2000 g/ha, in particular from 100 to 1500 g/ha.

When using the mixtures, the application rates for orysastrobin are correspondingly generally from 1 to 1000 g/ha, preferably from 10 to 750 g/ha, in particular from 20 to 500 g/ha.

Correspondingly, the application rates for the active compound II are generally from 1 to 1500 g/ha, preferably from 10 to 1250 g/ha, in particular from 20 to 1000 g/ha.

In the treatment of seed, application rates of mixture are generally from 1 to 2000 g/100 kg of seed, preferably from 1 to 1500 g/100 kg, in particular from 5 to 1000 g/100 kg.

For use in the method according to the invention, the compounds can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silicic acid, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable for use as surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene arid naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound. The active compounds are employed in a purity of from 90% to 100%, preferably 95% to 100% (according to NMR spectrum).

The following are examples of formulations:

1. Products for Dilution with Water

A Water-Soluble Concentrates (SL, LS)

10 parts by weight of the active compounds are dissolved with 90 parts by weight of water or a water-soluble solvent. As an alternative, wetters or other auxiliaries are added. The active compound dissolves upon dilution with water. In this way, a formulation having an active compound content of 10% by weight is obtained.

B Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight.

C Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is added to 30 parts by weight of water by means of an emulsifying machine (for example Ultraturrax) and made into a homogeneous emulsion. Dilution with water gives an emulsion. The formulation has an active compound content of 25% by weight.

E Suspensions (SC, OD, FS)

In an agitated ball mill, 20 parts by weight of the active compounds are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-Dispersible Granules and Water-Soluble Granules (WG, SG)

50 parts by weight of the active compounds are ground finely with addition of 50 parts by weight of dispersants and wetters and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

G Water-Dispersible Powders and Water-Soluble Powders (WP, SP, SS, WS)

75 parts by weight of the active compounds are ground in a rotor-stator mill with addition of 25 parts by weight of dispersants, wetters and silica gel. Dilution with water gives a stable dispersion or solution of the active compound. The active compound content of the formulation is 75% by weight.

H Gel Formulations

In a bead mill, 20 parts by weight of the active compounds, 10 parts by weight of dispersant, 1 part by weight of gelling agent and 70 parts by weight of water or an organic solvent are ground to give a fine suspension. Dilution with water gives a stable suspension having an active compound content of 20% by weight.

### 2. Products to be Applied Undiluted

I Dusts (DP, DS)

5 parts by weight of the active compounds are ground finely and mixed intimately with 95 parts by weight of finely divided kaolin. This gives a dustable product having an active compound content of 5% by weight.

J Granules (GR, FG, GG, MG)

0.5 part by weight of the active compounds is ground finely and associated with 99.5 parts by weight of carriers. Current methods are extrusion, spray-drying or the fluidized bed. This gives granules to be applied undiluted having an active compound content of 0.5% by weight.

K ULV solutions (UL)

10 parts by weight of the active compounds are dissolved in 90 parts by weight of an organic solvent, for example xylene. This gives a product to be applied undiluted having an active compound content of 10% by weight.

For seed treatment, it is customary to employ water-soluble concentrates (LS), suspensions (FS), dusts (DS), water-dispersible and water-soluble powders (WS, SS), emulsions (ES), emulsifiable concentrates (EC) and gel formulations (GF). These formulations can be applied to the seed undiluted or, preferably, diluted. Application can be prior to sowing.

Preference is given to using FS formulations for seed treatment. Usually, such formulations comprise from 1 to 800 g of active compound/l, from 1 to 200 g of surfactants/l, from 0 to 200 g of antifreeze agents/l, from 0 to 400 g of binders/l, from 0 to 200 g of colorants/l and solvents, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention..

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, with these concentrates being suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds even, if appropriate, not until immediately prior to use (tank mix). These agents are typically admixed with the compositions according to the invention in a weight ratio of from 1:100 to 100:1, preferably from 1:10 to 10:1.

Suitable adjuvants in this context are in particular: organic modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodiumdioctylsulfosuccinate, for example Leophen RA®.

Use Example

Seed dressing trial, activity against soybean rust

Soybean seeds of the cultivar BRS 133 were treated with 1000 g of orysastrobin/100 kg of seed, formulated as SC with 250 g of active compound per liter, as liquid dressing, then sown into pots and cultivated in a greenhouse at about 22° C. 3 weeks after sowing, the plants were inoculated with soybean rust, incubated at 100% relative atmospheric humidity for 24 hours and then again cultivated in the greenhouse. At the time of inoculation, the first pair of leaves and one subsequent leaf had developed. The infection of the leaves was assessed 11 days after the inoculation.

For the plants from pretreated seed, the total infection was less than 1%, whereas the plants from untreated-seed were 79% infected.

1-17. (canceled)

18. A method for controlling rust infections in leguminous plants, which method comprises applying a fungicidally effective amount of orysastrobin of the formula I 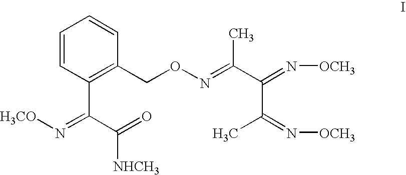
to the plants, the seeds or the soil.

19. The method according to claim 18, wherein said applying is carried out by spraying or dusting.

20. The method according to claim 18, wherein an aqueous preparation of a formulation comprising orysastrobin is applied to the above-ground parts of the plants.

21. The method according to claim 18, wherein the rust infection is controlled by applying said orysastrobin to seed or to soil.

22. The method according to claim 18, wherein Phakopsora pachyrhizi or Phakopsora meibomiae is controlled.

23. The method according to claim 18, further comprising applying at least one compound II selected from the group consisting of bromoconazole, cyproconazole, difenoconazole, epoxiconazole, fluquinconazole, flusilazole, flutriafol, hexaconazole, imazalil, metconazole, myclobutanil, penconazole, propiconazole, prochloraz, prothioconazole, tebuconazole, tetraconazole, triadimefon, triadimenol, triticonazole, benalaxyl, metalaxyl, mefenoxam, ofurace, oxadixyl, guazatine, pyrimethanil, mepanipyrim, cyprodinil, iprodione, procymidone, vinclozolin, mancozeb, metiram, thiram, benomyl, boscalid, carbendazim, carboxin, oxycarboxin, fuberidazole, picobenzamid, penthiopyrad, proquinazid, thiabendazole, thiophanate-methyl, fenpiclonil, fludioxonil, benthiavalicarb, cyflufenamid, fosetyl, fosetyl-aluminum, phosphorous acid or its salts, iprovalicarb, metrafenone, dimethomorph, flumetover and flumorph.

24. The method according to claim 23, further comprising applying at least one compound selected from the group consisting of imazethapyr, imazamox, imazapyr, imazapic, dimethenamid-p, fipronil, imidacloprid, acetamipird, nitenpyram, carbofuran, carbosulfan, benfuracarb, thiacloprid, clothianidin, MTI 446 and CGA 293343.

25. The method according to claim 23, wherein orysastrobin and said compound II are applied simultaneously, that is together or separately, or in succession.

26. The method according to claim 23, wherein orysastrobin and said compound II are applied in an amount of from 5 g/ha to 2500 g/ha.

27. The method according to claim 24, wherein orysastrobin and said compound are applied simultaneously, that is together or separately, or in succession.

28. The method according to claim 24, wherein orysastrobin and said compound are applied in an amount of from 5 g/ha to 2500 g/ha.

29. A fungicidal mixture for controlling rust fungi, which mixture comprises,
A) orysastrobin of the formula I, 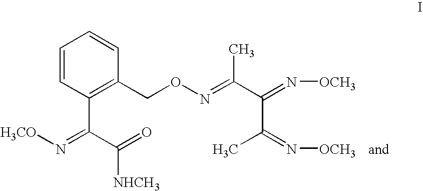
B) at least one compound II selected from the group consisting of bromoconazole, cyproconazole, difenoconazole, epoxiconazole, fluquinconazole, flusilazole, flutriafol, hexaconazole, imazalil, metconazole, myclobutanil, penconazole, propiconazole, prochloraz, tebuconazole, tetraconazole, triadimefon, triadimenol, triticonazole, benalaxyl, metalaxyl, mefenoxam, ofurace, oxadixyl, guazatine, pyrimethanil, mepanipyrim, cyprodinil, iprodione, procymidone, vinclozolin, mancozeb, metiram, thiram, benomyl, boscalid, carbendazim, carboxin, oxycarboxin, fuberidazole, picobenzamid, penthiopyrad, proquinazid, thiabendazole, thiophanate-methyl, fenpiclonil, fludioxonil, benthiavalicarb, cyflufenamid, fosetyl, fosetyl-aluminum, phosphorous acid or its salts, dimethomorph, flumetover and flumorph,
in synergistically effective amounts.

30. The fungicidal mixture according to claim 29, wherein said compound II is selected from the group consisting of bromoconazole, cyproconazole, difenoconazole, epoxiconazole, fluquinconazole, flusilazole, flutriafol, hexaconazole, imazalil, metconazole, myclobutanil, penconazole, propiconazole, prochloraz, tebuconazole, tetraconazole, triadimefon, triadimenol and triticonazole.

31. The fungicidal mixture according to claim 29, which comprises orysastrobin and said compound II in a weight ratio of from 100:1 to 1:100.

32. A fungicidal mixture comprising,
A) orysastrobin of the formula I, 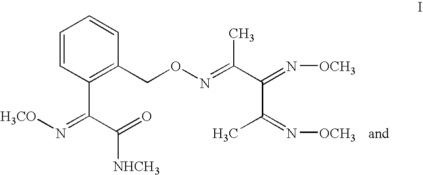
B) a compound II selected from the group consisting of imazethapyr, imazamox, imazapyr, imazapic and dimethenamid-p,
in a weight ratio of from 100:1 to 1:100.

33. The fungicidal mixture of claim 29, further comprising a liquid or solid carrier.

34. The fungicidal mixture of claim 32, further comprising a liquid or solid carrier.

35. The method according to claim 18, wherein said orysastrobin is applied in an amount of from 1 to 2000 g/100 kg seed.

36. Seed, comprising the mixture according to claim 29 in an amount of from 1 to 2000 g/100 kg seed.

37. Seed, comprising the mixture according to claim 32 in an amount of from 1 to 2000 g/100 kg seed.
